(19) United States
(12) Patent Application Publication
(10) Pub. No.: US 2020/0096648 A1
(43) Pub. Date: Mar. 26, 2020

(54) ZONE CORRECTION-BASED METHOD FOR IMPROVING THE POSITIONING ACCURACY IN A SATELLITE-BASED AUGMENTATION SYSTEM

(71) Applicant: SHANGHAI ASTRONOMICAL OBSERVATORY, CHINESE ACADEMY OF SCIENCES, Shanghai (CN)

(72) Inventors: Jianhua Zhou, Shanghai (CN); Junping Chen, Shanghai (CN); Yize Zhang, Shanghai (CN); Ahao Wang, Shanghai (CN); Bin Wang, Shanghai (CN); Weijie Tan, Shanghai (CN)

(21) Appl. No.: 16/309,438

(22) PCT Filed: Jun. 12, 2017
(86) PCT No.: PCT/CN2017/087922

§ 371 Date: Dec. 12, 2018

(30) Foreign Application Priority Data
Jun. 12, 2016 (CN) 201610407689.9

(51) Int. Cl. G01S 19/41; G01S 19/44; G01S 19/11; G01S 19/07

(52) U.S. Cl. CPC G01S 19/41; G01S 19/07; G01S 19/11; G01S 19/44

(57) ABSTRACT

A zone correction-based method for improving positioning accuracy in a satellite-based augmentation system, including: dividing an area to be observed into a plurality of observation areas, and configuring a plurality of monitoring stations in each observation area; acquiring residual of each monitoring station by processing observation data; acquiring mean clock error value of each monitoring station according to observation residual; acquiring ambiguity reduction value of each observation area according to residual data; acquiring zone corrections of each observation area according to residual data and ambiguity reduction value data; and providing a user with a zone corrections calling service by means of a network or a satellite link. The method carries out wide-range area configuration to monitoring stations and calculates the zone corrections for use in network and satellite-based broadcasts on the basis of the monitoring stations to refine error correction in user positioning.

### CROSS REFERENCE TO RELATED APPLICATIONS

This application is a national application of PCT/CN2017/087922, filed on Jun. 12, 2017. The contents of PCT/CN2017/087922 are all hereby incorporated by reference.

### FIELD OF THE INVENTION

The present application relates to a field of wide area satellite-based augmentation system, in particular to a zone correction-based method for improving the positioning accuracy in a satellite-based augmentation system.

### BACKGROUND OF THE INVENTION

The services provided by Global Navigation Satellite System (GNSS) include Legacy PNT (positioning, navigation and timing) and satellite-based augmentations. Wherein, in order to improve the accuracy of real-time service of the system, the basic idea of satellite-based augmentation is to distinguish the main error sources, such as satellite orbit error, satellite clock error and ionospheric delay and to establish a model of each error source for correcting errors of these parameters in Legacy PNT. These calculated corrections terms are called wide-area differential corrections. The satellite message uploading system broadcasts wide-area differential corrections to users through satellite links.

Current navigation augmentation systems mainly include American WAAS System (Wide-area Augmentation System), European EGNOS System (European Geostationary Navigation Overlay Service), Japanese MSAS System (Multi-functional Satellite Augmentation System) and Russian SDCM (Differential Corrections and Monitoring) System, etc. These systems are independent of the operation control systems of GPS or GLONASS (GLOBAL NAVIGATION SATELLITE SYSTEM), and calculate various differential corrections based on observation data of ground stations for correcting remaining-errors of Legacy broadcast messages.

The observations of navigation satellites include pseudo-range and carrier-phase. Theoretically, the accuracy of carrier-phase observation is about 100 times higher than that of pseudo-range. The carrier-phase observation data includes distance information between a satellite and a ground station and unknown integer ambiguity. In real-time processing mode, continuous processing of ambiguity has a relatively long convergence time. In the case of data interruption or cycle slip, ambiguity needs to be re-converged. Considering the complexity of the above carrier-phase data processing, a GPS/GLONASS satellite-based augmentation system usually uses pseudo-range observations to calculate the wide-area differential corrections of the orbits, clock and ionosphere errors. The Chinese regional satellite navigation system adopts an algorithm of satellite's equivalent clock error. The basic idea of equivalent clock is as follows: Firstly, correct the common errors of pseudo-range observation data of receivers with known positions of several stations to obtain a new distance observation; based on this, calculate the difference between distance observation and theoretical distance between the station and the satellite to form a residual observation; and then regard the residual observation to be completely the error of the station and satellite clock error, and solve for the corrections of the satellite clock error. As the influence of satellite orbit error is neglected in the above calculation process, the above calculation process is called equivalent clock error corrections.

Based on the broadcast message of satellite navigation and positioning system, satellite-based augmentation technology calculates differential correction information in real-time with higher accuracy and broadcasts it to users through satellite links. Chinese regional satellite navigation system adopts an integrative design for Legacy PNT and satellite-based augmentation, in which the satellite-based augmentation system provides more accurate service for authorized users in Beidou service area.

The differential information broadcast by Beidou navigation system includes equivalent clock and ionospheric grid corrections. Among them, the equivalent clock errors are mainly used to correct the fast-changing error of satellite clocks, while the ionospheric grid corrections are used to further improve the accuracy of ionospheric correction for single-frequency users. The positioning accuracy of Beidou authorized users is about 5 meters after using the wide-area differential corrections broadcast by the system, which is obviously improved compared with the service accuracy of Legacy PNT of 10 meters.

However, the processing technology of existing satellite-based augmentation systems has the following problems: (1) only pseudo-range observations are used, and the wide-area differential corrections are affected by pseudo-range's accuracy, which limit the improvement of positioning accuracy; (2) if carrier-phase observations are used, the ambiguity and cycle slip in carrier-phase observation will result in a long convergence time in corresponding data processing; (3) correction of space propagation segment (mainly ionosphere) is also based on pseudo-range observations, which limits the improvement of positioning accuracy.

At present, satellite-based augmentation processing only uses pseudo-range observation data, so its service accuracy is just limited to meter level, which cannot meet wide-area users' requirements of positioning with higher accuracy.

### SUMMARY OF THE INVENTION

The present application provides a zone correction-based method for improving the positioning accuracy in a satellite-based augmentation system, which carries out wide-range area (zone) configuration and calculates the zone corrections using observations of ground-tracking stations, and broadcasts the zone corrections through internet or satellite links. Thus the method refines error correction models in user positioning, thereby improving the accuracy of user positioning and has the advantages of a wide application range.

To achieve the above purpose, the present application provides a method for improving the positioning accuracy of a satellite-based augmentation system based on zone correction, comprising the following steps:

S1: dividing an area to be observed into a plurality of areas, and configuring a plurality of monitoring stations in each area;

S2: the monitoring station observing at least one satellite to obtain observation data;

S3: acquiring residual data of each monitoring station by using the observation data, including pseudo-range and carrier-phase observation;

S4: acquiring mean clock errors data of each monitoring station by using the pseudo-range observation residual;

S5: acquiring ambiguity reduction value of each monitoring station by using the carrier-phase observation residual;

S6: acquiring zone corrections of each observation area by using the residual and the ambiguity reduction value of all tracking stations in the same area, the zone corrections comprising pseudo-range zone corrections and carrier-phase zone corrections;

S7: providing user stations with zone corrections calling service through network or satellite link, wherein the user station obtains three-dimensional coordinates of the user station by calling the zone corrections.

Further, in the step S3, the residuals are obtained by using the observation data and formula (1) to calculate the pseudo-range and carrier phase residuals ΔPᵢ^{j}(f) and ΔLᵢ^{j}; (f) of j-th satellite by i-th monitoring station:

$$\{ \begin{matrix}Δ {P}_{i}^{j} ( f ) = d {ρ}_{i}^{j} + c \cdot {dt}_{i} - c \cdot Δ {dt}^{j} + Δ {I}_{i}^{j} ( f ) + Δ {D}_{i}^{j} + {δ}_{i}^{j} \\ Δ {L}_{i}^{j} ( f ) = d {ρ}_{i}^{j} + c \cdot d {t}_{i} - c \cdot Δ d {t}^{j} + {N}_{i}^{j} - Δ {I}_{i}^{j} ( f ) + Δ {D}_{i}^{j} + {v}_{i}^{j}\end{matrix} \qquad ( 1 )$$

Wherein, i and j are natural value greater than zero; f is frequency; dρᵢ^{j} is the distance observation error between the i-th monitoring station and the j-th satellite; c is the speed of light; dtᵢ is the monitoring station clock error of the i-th monitoring station; dt^{j} is the satellite clock error of the j-th monitoring station; Nᵢ^{j} is ambiguity parameter; Δlᵢ^{j}(f) is delay correction error of ionospheric model related to frequency; Dᵢ^{j} is the tropospheric delay between the i-th monitoring station and the j-th satellite; ΔDᵢ^{j} is the error of tropospheric delay model between the i-th monitoring station and the j-th satellite; δᵢ^{j} and νᵢ^{j} is the other residual error of pseudo-range and carrier phase between the i-th monitoring station and the j-th satellite.

Further, in the step S4, mean clock error of the i-th monitoring station c·dt̅ᵢ are obtained by using the pseudo-range observation residual follows in formula (2):

$$c \cdot d {\overline{t}}_{i} = \frac{{\sum }_{j = 1}^{n} Δ {P}_{i}^{j} ( f )}{n} \qquad ( 2 )$$

Wherein, n is the total number of satellites observed at the i-th monitoring station.

Further, in the step S5, the ambiguity reduction value of each area dΔL′ᵢ^{j}(f)|ₜ are obtained by using the carrier-phase observation residual follows in formula (3);

$$\{ \begin{matrix}d Δ {L}_{i}^{′ j} ( f ) {\vert}_{t} = \frac{{\sum }_{i = 1}^{m} ( Δ {L}_{i}^{′ j} ( f ) {\vert}_{t} - Δ {L}_{i}^{′ j} ( f ) {\vert}_{t - 1} )}{m} \\ Δ {L}_{i}^{′ j} ( f ) = Δ {L}_{i}^{j} ( f ) - c \cdot d {\overline{t}}_{i} + {v}_{i}^{j}\end{matrix} \qquad ( 3 )$$

Wherein, ΔL′ᵢ^{j}(f) is the carrier-phase residual corrections after deducting the monitoring station clock error; m is the number of the monitoring stations in the current observation area; c·dt̅ᵢ is the mean clock error of the i-th monitoring station; and t is epoch number.

Further, in step S6, the pseudo-range zone correction ΔP^{j}(f) and carrier-phase zone corrections ΔL^{j}(f)|ₜ are obtained by using the residual and the ambiguity reduction value follows in formula (4):

$$\{ \begin{matrix}Δ {P}^{j} ( f ) = \frac{{\sum }_{i = 1}^{m} Δ {P}_{i}^{′ j} ( f )}{m} \\ Δ {L}^{j} ( f ) {\vert}_{t} = Δ {L}_{i}^{′ j} ( f ) {\vert}_{t - 1} + d Δ {L}_{i}^{′ j} ( f ) {\vert}_{t} \\ Δ {P}_{i}^{′ j} ( f ) = Δ {P}_{i}^{j} ( f ) - c \cdot d {\overline{t}}_{i} + {δ}_{i}^{j}\end{matrix} \qquad ( 4 )$$

Wherein, t is epoch number, and c·dt̅ᵢ is mean clock error of the monitoring stations.

Due to the adoption of the above technical solution, the present application has the following beneficial effects:

In the present application, a calling service can be provided to users after sending zone corrections acquired by a specific algorithm to a forwarding server. Thus, by users calling and using the zone corrections as desired, the method refines error correction in user positioning, thereby improving the accuracy of user positioning and has the advantages of a wide application range.

### BRIEF DESCRIPTION OF THE DRAWINGS

These and other features and advantages of this application will become more apparent to those skilled in the art from the detailed description of preferred embodiment. The drawings that accompany the description are described below.

Wherein, FIG. 1 is a flow diagram of a zone correction-based method for improving the positioning accuracy in a satellite-based augmentation system according to an embodiment of the present application.

FIG. 2 is a diagram illustrating the division of a plurality of observation areas according to an embodiment of the present application.

### DESCRIPTION OF THE PREFERRED EMBODIMENTS

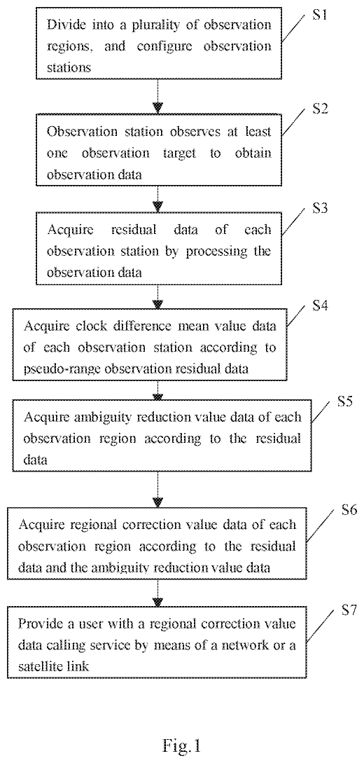

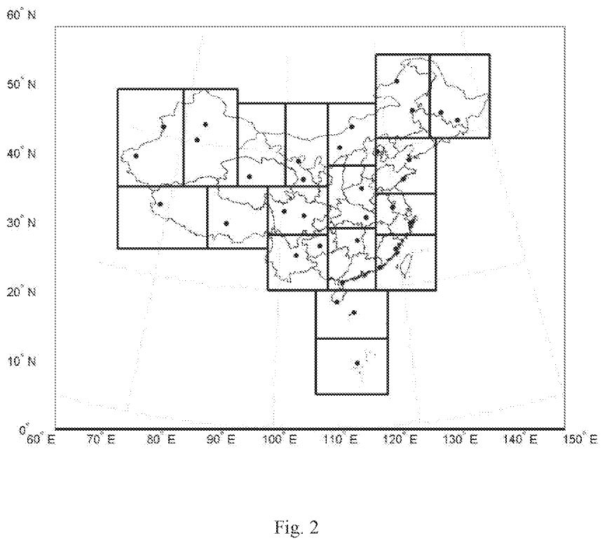

The followings are used to present and further illustrate preferred embodiments of the present application with FIGS. 1-2, so as to better understand the functions and the features of the present application.

As shown in FIG. 1, the zone correction-based method for improving positioning accuracy of a satellite-based augmentation system according to the present application includes steps:

S1: Dividing an area to be observed into a plurality of areas, and configuring a plurality of monitoring stations in each observation area;

S2: The monitoring station observes at least one satellite and obtains observation data;

S3: Acquiring residual data of each monitoring station by processing observation data, including pseudo-range and carrier-phase residual;

Specifically, in step S3, the residuals are obtained by processing the observation data and formula (1) to calculate the pseudo-range and carrier-phase residual ΔLᵢ^{j}(f) and ΔLᵢ^{j}(f) of j-th satellite by i-th monitoring station and:

$$\{ \begin{matrix}Δ {P}_{i}^{j} ( f ) = d {ρ}_{i}^{j} + c \cdot {dt}_{i} - c \cdot Δ {dt}^{j} + Δ {I}_{i}^{j} ( f ) + Δ {D}_{i}^{j} + {δ}_{i}^{j} \\ Δ {L}_{i}^{j} ( f ) = d {ρ}_{i}^{j} + c \cdot {dt}_{i} - c \cdot Δ {dt}^{j} + {N}_{i}^{j} - Δ {I}_{i}^{j} ( f ) + Δ {D}_{i}^{j} + {v}_{i}^{j}\end{matrix} \qquad ( 1 )$$

Wherein, i and j are natural numbers greater than zero; f is frequency; dρᵢ^{j} is the distance observation error between the i-th monitoring station and the j-th satellite; c is the speed of light; dtᵢ is the monitoring station clock error of the i-th monitoring station; dt^{j} is the satellite clock error of the j-th station; Nᵢ^{j} is the ambiguity parameter; ΔIᵢ^{j}(f) is delay correction error of the ionospheric model related to frequency; Dᵢ^{j} is the tropospheric delay between the i-th monitoring station and the j-th satellite; ΔDᵢ^{j} is the error of tropospheric delay model between the i-th monitoring station and the j-th satellite; δᵢ^{j} is the other residual error of pseudo-range and carrier phase between the i-th monitoring station and the j-th satellite.

S4: Acquiring mean clock errors of each monitoring station by processing pseudo-range observation residual;

Specifically, in step S4, mean clock error of the i-th monitoring station c·dt̅ᵢ are obtained by processing pseudo-range observation residual follows in formula (2):

$$c \cdot d {\overline{t}}_{i} = \frac{{\sum }_{j = 1}^{n} Δ {P}_{i}^{j} ( f )}{n} \qquad ( 2 )$$

Wherein, n is the total number of satellites observed at the i-th monitoring station.

S5: Acquiring ambiguity reduction value of each monitoring station by processing the carrier-phase observation residual;

Specifically, in step S5, the ambiguity reduction value of each observation area dΔL′ᵢ^{j}(f)|ₜ are obtained by processing the carrier-phase observation residual follows in formula (3);

$$\{ \begin{matrix}d Δ {L}_{i}^{′ j} ( f ) {\vert}_{t} = \frac{{\sum }_{i = 1}^{m} ( Δ {L}_{i}^{′ j} ( f ) {\vert}_{t} - Δ {L}_{t}^{′ j} ( f ) {\vert}_{t - 1} )}{m} \\ Δ {L}_{i}^{′ j} ( f ) = Δ {L}_{i}^{j} ( f ) - c \cdot d {\overline{t}}_{i} + {v}_{i}^{j}\end{matrix} \qquad ( 3 )$$

Wherein, ΔL′ᵢ^{j}(f) is the carrier-phase residual corrections after deducting the monitoring station clock error; m is the number of monitoring stations in the current observation area; c·dt̅ᵢ is the mean clock error of the i-th monitoring station; and t is epoch number.

S6: Acquiring zone corrections of each observation area by processing the residual and the ambiguity reduction value of all tracking stations in the same area, the zone corrections comprising pseudo-range zone corrections and carrier-phase zone corrections;

Specifically, in step S6, the pseudo-range zone correction ΔP^{j}(f) and carrier-phase zone corrections ΔL^{j}(f)|ₜ are obtained by processing the residual and the ambiguity reduction value follows in formula (4):

$$\{ \begin{matrix}Δ {P}^{j} ( f ) = \frac{{\sum }_{i = 1}^{m} Δ {P}_{i}^{′ j} ( f )}{m} \\ Δ {L}^{j} ( f ) {\vert}_{t} = Δ {L}_{i}^{′ j} ( f ) {\vert}_{t - 1} + d Δ {L}_{i}^{′ j} ( f ) {\vert}_{t} \\ Δ {P}_{i}^{′ j} ( f ) = Δ {P}_{i}^{j} ( f ) - c \cdot d {\overline{t}}_{i} + {δ}_{i}^{j}\end{matrix} \qquad ( 4 )$$

Wherein, t is epoch number, and c·dt̅ᵢ is mean clock error of monitoring stations.

S7: Sending the zone corrections to a forwarding server and provide calling service to a user station through network or satellite link, wherein the user station improves the accuracy of its position by calling the zone corrections.

The following is a further description of the method for improving the positioning accuracy of the satellite-based augmentation system based on zone correction according to the present application.

The contents of the present application include a calculation model of the carrier-phase zone correction of satellite-based augmentation and a zone design suitable for a satellite-based augmentation system.

(1) Firstly, for any epoch monitoring station i, the pseudo-range and carrier-phase observations of the observed target (e.g. satellite) J at the frequency point F are:

$$\{ \begin{matrix}{P}_{i}^{j} ( f ) = {ρ}_{i}^{j} + c \cdot ( {dt}_{i} - {dt}^{j} ) + {I}_{i}^{J} ( f ) + {D}_{i}^{j} + {δ}_{i}^{j} \\ {L}_{i}^{j} ( f ) = {ρ}_{i}^{j} + c \cdot ( {dt}_{i} - {dt}^{j} ) + {N}_{i}^{j} ( f ) - {I}_{i}^{j} ( f ) + Δ {D}_{i}^{j} + {v}_{i}^{j}\end{matrix} \qquad ( 5 )$$

In formula (5), Pᵢ^{j}(f) and Lᵢ^{j}(f) is the pseudo-range and carrier-phase observations of satellite j by monitoring station i; f is the frequency; ρᵢ^{j} is the theoretical geometric distance between i-th monitoring station and j-th satellite; c is the speed of light; dtᵢ is the monitoring station clock error of the i-th monitoring station; dt^{j} is the satellite clock error of the j-th satellite; Nᵢ^{j}(f) is the ambiguity of carrier-phase observations of j-th satellite and i-th monitoring station, Iᵢ^{j}(f) is the ionospheric delay related to frequency, which delays observation time for pseudo-range while shorten it for carrier-phase observation respectively; Dᵢ^{j} is the tropospheric delay based on theoretical model; δᵢ^{j} and νᵢ^{j} are the other residual error of pseudo-range and carrier phase between the i-th monitoring station and the j-th satellite, which contains noise information such as multi-path error.

In Formula (5), the monitoring station has been given the orbits and clock errors of the observation target solved by coordinates and the broadcast ephemeris, and corrects the atmospheric delay (ionosphere and troposphere) by using the measured meteorological data and the empirical model, which can solve pseudo-range observation residuals ΔPⱼ^{j}(f) of the j-th observation target by the i-th monitoring station and carrier-phase residuals ΔLᵢ^{j}(f) of the j-th satellite by the i-th monitoring station.

$$\{ \begin{matrix}Δ {P}_{i}^{j} ( f ) = d {ρ}_{i}^{j} + c \cdot {dt}_{i} - c \cdot Δ {dt}^{j} + Δ {I}_{i}^{j} ( f ) + Δ {D}_{i}^{j} + {δ}_{i}^{j} \\ Δ {L}_{i}^{j} ( f ) = d {ρ}_{i}^{j} + c \cdot {dt}_{i} - c \cdot Δ {dt}^{j} + {N}_{i}^{j} - Δ {I}_{i}^{j} ( f ) + Δ {D}_{i}^{j} + {v}_{i}^{j}\end{matrix} \qquad ( 1 )$$

In formula (1), dρᵢ^{j}, Δdt^{j} are the observation errors of the i-th monitoring station caused by the orbit and clock error of the j-th satellite, respectively. ΔIᵢ^{j}(f), ΔDᵢ^{j} are the residual errors after ionospheric and tropospheric model correction, respectively. The clock error dtᵢ and the ambiguity parameter Nᵢ^{j} of the monitoring station are the largest items among the observation residuals. ΔPᵢ^{j}(f), ΔLᵢ^{j}(f) are residual correction of the monitoring station, which can be provided to users as local/wide-area augmentation information.

At the same epoch, the pseudo-range and the carrier-phase observation of the satellite j by a user station u at frequency point f are:

$$\{ \begin{matrix}{P}_{u}^{j} ( f ) = {ρ}_{u}^{j} + c \cdot ( {dt}_{u} - {dt}^{j} ) + {I}_{u}^{j} ( f ) + {D}_{u}^{j} + {δ}_{u}^{j} \\ {L}_{u}^{j} ( f ) = {ρ}_{u}^{j} + c \cdot ( {dt}_{u} - {dt}^{j} ) + {N}_{u}^{j} ( f ) - {I}_{u}^{j} ( f ) + {D}_{u}^{j} + {v}_{u}^{j}\end{matrix} \qquad ( 6 )$$

The meanings of variables in formula (6) are the same as those in formula (5), except that the station changes from a monitoring station i to a user station u.

Wherein, Dᵤ^{j} represents tropospheric delay of user station; δᵤ^{j} represents the other residual error between user station and j-th satellite;

Iᵤ^{j}(f) represents the correction error of ionospheric model at the user station;

Nᵤ^{j}(f) represents the ambiguity of carrier-phase observations for station j by user station u;

dtᵤ represents the user station clock error.

By putting the orbit and clock error of satellite j using the broadcast ephemeris into formula (6), and by correcting the atmospheric delay (ionosphere and troposphere) using the measured meteorological data and the empirical model, it can be obtained that:

$$\{ \begin{matrix}{P}_{u}^{j} ( f ) = {ρ}_{u}^{′ j} + d {ρ}_{u}^{j} + c \cdot {dt}_{i} - c \cdot Δ {dt}^{j} + Δ {I}_{u}^{j} ( f ) + Δ {D}_{u}^{j} + {δ}_{u}^{j} \\ {L}_{u}^{j} ( f ) = {ρ}_{u}^{′ j} + d {ρ}_{u}^{j} + c \cdot {dt}_{i} - c \cdot Δ {dt}^{j} + {N}_{u}^{j} ( f ) - Δ {I}_{u}^{j} ( f ) + Δ {D}_{u}^{j} + {v}_{u}^{j}\end{matrix} \qquad ( 7 )$$

In formula (7), ρ′ᵤ^{j} is the distance between satellite and station calculated based on broadcast ephemeris; and dμᵤ^{j} is the observation error of the user station u caused by satellite orbit error. By introducing the residual corrections ΔPᵢ^{j}(f), ΔLᵢ^{j}(f) on monitoring station i into formula (7), the formula is written as follows:

$$\{ \begin{matrix}{P}_{u}^{j} ( f ) = {ρ}_{u}^{′ j} + d {ρ}_{u}^{j} + c \cdot {dt}_{i} - c \cdot Δ {dt}^{j} + Δ {I}_{u}^{j} ( f ) + Δ {D}_{u}^{j} - Δ {P}_{i}^{j} ( f ) + {δ}_{u}^{j} \\ \begin{matrix}{L}_{u}^{j} ( f ) = {ρ}_{u}^{′ j} + d {ρ}_{u}^{j} + c \cdot {dt}_{i} - c \cdot Δ {dt}^{j} + \\ {N}_{u}^{j} ( f ) - Δ {I}_{u}^{j} ( f ) + Δ {D}_{u}^{j} - Δ {L}_{i}^{j} ( f ) + {v}_{u}^{j}\end{matrix}\end{matrix} \qquad ( 8 )$$

By subtracting formula (1) into formula (8), it can be obtained that:

$$\{ \begin{matrix}\begin{matrix}{P}_{u}^{j} ( f ) = {ρ}_{u}^{′ j} + ( d {ρ}_{u}^{j} - d {ρ}_{i}^{j} ) + c \cdot ( {dt}_{u} - {dt}_{i} ) + Δ {I}_{u}^{j} ( f ) - Δ {I}_{i}^{j} ( f ) + \\ Δ {D}_{u}^{j} - Δ {D}_{i}^{j} + δ\end{matrix} \\ \begin{matrix}{L}_{u}^{j} ( f ) = {ρ}_{u}^{′ j} + ( d {ρ}_{u}^{j} - d {ρ}_{i}^{j} ) + c \cdot ( {dt}_{u} - {dt}_{i} ) + ( {N}_{u}^{j} - {N}_{i}^{j} ) + Δ {I}_{u}^{j} ( f ) - \\ Δ {I}_{i}^{j} ( f ) + Δ {D}_{u}^{j} - Δ {D}_{i}^{j} + ɛ\end{matrix}\end{matrix} \qquad ( 9 )$$

Wherein, δᵢ^{j} is pseudo-range residual error and observation noise; and νᵢ^{j} is carrier-phase residual error and observation noise.

In formula (9), the satellite clock error c·Δdt^{j} is eliminated. If the distance between the user station and the monitoring station is less than 2000 km, the influence of (dρᵤ^{j}−dρᵢ^{j}) will also be negligible at millimeter level. The station clock error c·dtᵢ of the monitoring station can be completely absorbed by the user station clock error c·dtᵤ and become a new station clock error c·dt̅ᵤ̅. Nᵤ^{j}−Nᵢ^{j} will be recombined into a new ambiguity parameter N̅ᵤ̅^̅{̅j̅}̅ if without cycle slip at both the monitoring station and the user station. Through the above analysis, after recombining some of the items, the formula (9) can be rewritten as follows:

$$\{ \begin{matrix}{P}_{u}^{j} ( f ) = {ρ}_{u}^{′ j} + c \cdot d \overline{{t}_{u}} + Δ {I}_{u}^{j} ( f ) - Δ {I}_{i}^{j} ( f ) + Δ {D}_{u}^{j} - Δ {D}_{i}^{j} + δ \\ {L}_{u}^{j} ( f ) = {ρ}_{u}^{′ j} + c \cdot d \overline{{t}_{u}} + \overline{{N}_{u}^{j}} + Δ {I}_{u}^{j} ( f ) - Δ {I}_{i}^{j} ( f ) + Δ {D}_{u}^{j} - Δ {D}_{u}^{j} + ɛ\end{matrix} \qquad ( 10 )$$

Compared with conventional observation equations, formula (10) eliminates the influence of the satellite clock error by using the residual error provided by the monitoring station; moreover, as for the stations thousands of kilometers away from the monitoring station, the common part on which the ionospheric and tropospheric errors has the greatest influence has been eliminated in formula (10), thus reducing the influence of these two parts. Therefore, based on the residual correction provided by the monitoring station, the error correction in user positioning can be refined and the accuracy of user positioning can be improved.

(2) About the calculation of the mean clock error value of different monitoring stations and the ambiguity reduction of common satellites of different monitoring stations.

The carrier-phase corrections comprises some ambiguity residual terms. As for the same satellite, the numbers of stations observed at different epochs are different. If the ambiguity of common satellite is not reduced, the ambiguity residual terms contained in the carrier-phase synthesis corrections will be different, which will lead to discontinuity of the carrier-phase synthesis corrections.

The descriptions above are based on that a single monitoring station which can provide the corresponding pseudo-range and carrier-phase correction information. The monitoring station clock error contained in the station residual errors can be absorbed by the user station clock error. Thus, in order to reduce the number of digits of the parameters, the mean clock error value can be deducted from the residual errors of formula (1) to form new residual corrections:

$$\{ \begin{matrix}Δ {P}_{i}^{′ j} ( f ) = Δ {P}_{i}^{j} ( f ) - c \cdot d {\overline{t}}_{i} + {δ}_{i}^{j} \\ Δ {L}_{i}^{′ j} ( f ) = Δ {L}_{i}^{j} ( f ) - c \cdot d {\overline{t}}_{i} + {v}_{i}^{j}\end{matrix} \qquad ( 11 )$$

In formula (11), ΔP′ᵢ^{j}(f), ΔL′ᵢ^{j}(f) are corrections of residual errors of pseudo-range and carrier-phase after deducting the clock error of the monitoring station, respectively; c·dt̅ᵢ is the approximate value of the monitoring station clock error, which can be calculated by the pseudo-range error in formula (1):

$$c \cdot d {\overline{t}}_{i} = \frac{{\sum }_{j = 1}^{n} Δ {P}_{i}^{j} ( f )}{n} \qquad ( 2 )$$

In formula (2), n is the total number of satellites observed at monitoring station i.

A single monitoring station may have problems like signal breakdown, thus affecting the continuity of service. Multiple monitoring stations can be established in a certain region, so as to extend a single station model to a multiple monitoring stations model. Referring to formula (10), at any epoch, after the user station u receiving the corrections of the monitoring station k, the pseudo-range and carrier-phase observations of satellite j at frequency band f are as follows:

$$\{ \begin{matrix}{P}_{u}^{j} ( f ) = {ρ}_{u}^{′ j} + c \cdot d \overline{\overline{{t}_{u}}} + Δ {I}_{u}^{j} ( f ) - Δ {I}_{k}^{j} ( f ) + Δ {D}_{u}^{j} - Δ {D}_{k}^{j} + {δ}^{′} \\ {L}_{u}^{j} ( f ) = {ρ}_{u}^{′ j} + c \cdot d \overline{\overline{{t}_{u}}} + \overline{\overline{{N}_{u}^{j}}} + Δ {I}_{u}^{j} ( f ) - Δ {I}_{k}^{j} ( f ) + Δ {D}_{u}^{j} - Δ {D}_{k}^{j} + {ɛ}^{′}\end{matrix}$$

(12)

In formula 12,

dt̅ᵤ̅ represents a new station clock error of the user station;

N̅ᵤ̅^̅{̅j̅}̅ represents a new ambiguity parameter combined;

ρ′ᵤ^{j} represents the distance between the satellite and the station based on broadcast ephemeris;

ΔIᵤ^{j}(f) represents the residual error of the ionospheric model correction at the user station;

ΔIₖ^{j}(f) represents the residual error of the ionospheric model correction at the monitoring station k;

ΔDᵤ^{j} represents the residual error of the tropospheric model correction at the user station;

ΔDₖ^{j} represents the residual error of the tropospheric model correction at the monitoring station k;

δ′ represents the pseudo-range residual error and observation noise;

ε′ represents the carrier-phase residual error and observation noise.

Comparing formula (10) and formula (12), it can be seen that besides differences in ionospheric and tropospheric corrections error, there are differences between these two formulas in clock error and ambiguity since the clock error and ambiguity are the results of combining the related items of different monitoring stations. As the station clock error is solved at each epoch, clock error's jumping change caused by different stations will directly affect the user station clock error, but will not affect user positioning results. The change of ambiguity information in adjacent epochs will lead to cycle slip of users, which will lead to the jumping change of user positioning results. Therefore, in order to ensure the stability and continuity of user positioning, when a breakdown occurs at one monitoring station and a switch to another one is needed, it is necessary to ensure the continuity of user ambiguity parameters. In which, it is required to keep the ambiguity parameters of the same satellite the same by different monitoring stations.

According to formula (1), It can be obtained from the difference between the residual errors of the two monitoring stations that:

$$\{ \begin{matrix}Δ {P}_{i , k}^{j} ( f ) = d {ρ}_{i , k}^{j} + c \cdot {dt}_{i , k} + Δ {I}_{i , k}^{j} ( f ) + Δ {D}_{i , k}^{j} + {δ}_{i , k}^{j} \\ Δ {L}_{i , k}^{j} ( f ) = d {ρ}_{i , k}^{j} + c \cdot {dt}_{i , k} + {N}_{i , k}^{j} - Δ {I}_{i , k}^{j} ( f ) + Δ {D}_{i , k}^{j} + {v}_{i , k}^{j}\end{matrix} \qquad ( 13 )$$

The subscript i, k in formula (13) represents the difference between two monitoring stations. In formula (13), to ensure the consistency of the ambiguity parameters of the same satellite by the two different monitoring stations, the ambiguity of all satellite by the two monitoring stations must be the same or differ from each other by a constant N_{i,k}^{j}. In fact, the difference between the ambiguities of different satellite by different monitoring stations is not constant, so it is necessary to calculate the ambiguity of the same satellite by multiple monitoring stations.

The ambiguity reduction is to ensure the continuity of the carrier-phase zone synthesis corrections, that is to say, it is necessary to ensure that the ambiguities contained in the former and latter epochs are the same. As for an observed satellite, if the number of monitoring stations used to calculate its synthesis corrections in the former and latter epochs changes, the common monitoring station data in the former and latter epochs will be used to calculate the change of the mean value of its corrections (deducting the station clock error):

$$d Δ {L}_{i}^{′ j} ( f ) {\vert}_{t} = \frac{{\sum }_{i = 1}^{m} ( Δ {L}_{i}^{′ j} ( f ) {{\vert}_{t} - Δ {L}_{i}^{′ j} ( f ) \vert}_{t - 1} )}{m} \qquad ( 14 )$$

In formula (14), dΔL′ᵢ^{j}(f)|ₜ is the change between the comprehensive corrections of adjacent epochs, i.e. the reduction value of ambiguity; m is the number of the monitoring stations that observe satellite j, and subscript t represents the epoch number. When the number of monitoring stations changes, the continuity of ambiguity parameters can be ensured by adding the above ambiguity reduction values to the ambiguity parameters of the observation target by the former epoch.

(3) About the Acquisition of Zone Correction Data.

After the monitoring station's clock error and ambiguity reduction, the residual corrections of different monitoring stations in the same zone can be synthesized to form the corrections of each satellite in each zone, that is, the synthesis zone corrections.

The synthesis zone corrections of multiple monitoring stations comprise synthesis of pseudo-range corrections and synthesis of carrier-phase corrections. That is to say, the zone corrections include pseudo-range zone correction and carrier-phase zone correction. The difference between pseudo-range corrections from which different monitoring stations have deducted the mean clock error value mainly refers to the difference in observation noise, so it can be directly and synthetically averaged. When the multi-station carrier-phase zone corrections are synthesized, they can be directly accumulated through ambiguity reduction:

$$\{ \begin{matrix}Δ {P}^{j} ( f ) = \frac{{\sum }_{i = 1}^{m} Δ {P}_{i}^{′ j} ( f )}{m} \\ Δ {L}^{j} ( f ) {\vert}_{t} = Δ {L}_{i}^{′ j} ( f ) {\vert}_{t - 1} + d Δ {L}_{i}^{′ j} ( f ) {\vert}_{t}\end{matrix} \qquad ( 15 )$$

The subscript t, t−1 in formula (15) represents the epoch number, in which the carrier-phase zone synthesis corrections of the initial epoch are:

$$Δ {L}^{j} ( f ) = \frac{{\sum }_{i = 1}^{m} Δ {L}_{i}^{′ j} ( f )}{m} \qquad ( 16 )$$

After acquiring the synthesis zone corrections, it can be sent to the user through network or satellite link for use.

(4) About the Division of Observation Areas

The zone correction model based on station residual error correction proposed by the present application can be applied to a satellite-based augmentation system of Beidou satellite navigation system. The Beidou service area can be zonal designed according to the distribution of existing monitoring stations and the demand of system service indicators.

As for key service areas, such as the southeastern coastal areas of China, the distribution of the zones can be appropriately dense. It should be ensured that there are at least two monitoring stations in each zone. Each monitoring station should be distributed as evenly as possible or in the zoning center. In addition, some new monitoring stations can be added later as desired.

For example, see FIG. 2. According to a zonal design of observation areas in the present embodiment, each zone covers an area of different scope and each zone contains several monitoring stations. The specific coordinates of zones can be seen in Table 1.

TABLE 1
grid point coordinates of zones

| Zone | westernmost | easternmost | southernmost | northernmost |
|---|---|---|---|---|
| number | (E) | (E) | (N) | (N) |
| 1 | 108 | 116 | 38 | 47 |
| 2 | 125 | 135 | 42 | 54 |
| 3 | 116 | 125 | 42 | 54 |
| 4 | 116 | 126 | 34 | 42 |
| 5 | 116 | 126 | 28 | 34 |
| 6 | 116 | 126 | 20 | 28 |
| 7 | 106 | 118 | 13 | 20 |
| 8 | 106 | 118 | 5 | 13 |
| 9 | 101 | 108 | 35 | 47 |
| 10 | 108 | 116 | 29 | 38 |
| 11 | 108 | 116 | 20 | 29 |
| 12 | 98 | 108 | 20 | 28 |
| 13 | 93 | 101 | 35 | 47 |
| 14 | 98 | 108 | 28 | 35 |
| 15 | 88 | 98 | 26 | 35 |
| 16 | 84 | 93 | 35 | 49 |
| 17 | 73 | 84 | 35 | 49 |
| 18 | 73 | 88 | 26 | 35 |

Take eastern China zone for example. Suppose three monitoring stations, Nanjing, Shanghai and Hangzhou, are set up in eastern China. The zone corrections of each satellite are calculated at each epoch. The calculation steps are as follows:

1) Calculating Residual Errors of Each Monitoring Station

Take satellite No. 1 for example. According to formula (1), the calculation results of the pseudo-range and carrier-phase residual errors of each monitoring station at different epochs 1, 2, 3 and 4 are shown in Table 2.

TABLE 2
Pseudo-range and carrier-phase zone correction
of a single monitoring station

| | Pseudo-range Residual Error | | | Carrier-phase Residual Error | | |
|---|---|---|---|---|---|---|
| Epoch | Nanjing | Shanghai | Hangzhou | Nanjing | Shanghai | Hangzhou |
| 1 | 101.231 | 50.946 | 10.783 | 100.534 | 50.648 | 10.331 |
| 2 | 101.346 | 50.992 | 10.832 | 100.523 | 50.633 | 10.327 |
| 3 | 101.127 | 50.893 | — | 100.567 | 50.672 | — |
| 4 | 101.282 | 51.011 | — | 100.583 | 50.687 | — |

Note:
—indicates no data or that data has been excluded.

2) Calculating Mean Clock Error Value of Different Monitoring Stations

According to formula (2), the mean clock error value of different monitoring stations is calculated and deducted. The calculation results are shown in Table 3.

TABLE 3
Mean clock error value after deducting the station
clock errors of different monitoring stations

| | Pseudo-range Residual Error | | | Carrier-phase Residual Error | | |
|---|---|---|---|---|---|---|
| Epoch | Nanjing | Shanghai | Hangzhou | Nanjing | Shanghai | Hangzhou |
| 1 | 1.231 | 0.946 | 0.783 | 0.534 | 0.648 | 0.331 |
| 2 | 1.346 | 0.992 | 0.832 | 0.523 | 0.633 | 0.327 |
| 3 | 1.127 | 0.893 | — | 0.567 | 0.672 | — |
| 4 | 1.282 | 1.011 | — | 0.583 | 0.687 | — |

3) Ambiguity Reduction of Public Satellites of Multiple Monitoring Stations

According to formula (3), the satellite ambiguity is reduced by the carrier-phase corrections of different monitoring stations. The calculation results are shown in Table 4.

TABLE 4
Ambiguity reduction value of satellites for
multiple monitoring stations

| | Ambiguity |
|---|---|
| Epoch | Reduction Value |
| 1 | — |
| 2 | −0.010 |
| 3 | 0.0415 |
| 4 | 0.0155 |

4) Zone Corrections Synthesis

According to formula (13), the zone corrections are synthesized, and pseudo-range zone corrections and carrier-phase zone corrections are obtained. The calculation results are shown in Table 5.

TABLE 5
Zone synthesis corrections

| | Pseudo-range | Carrier-phase |
|---|---|---|
| Epoch | zone corrections | zone corrections |
| 1 | 0.9867 | 0.5043 |
| 2 | 1.0567 | 0.4943 |
| 3 | 1.0100 | 0.5358 |
| 4 | 1.1465 | 0.5513 |

The present application makes a wide-area zonal design for observation areas, and calculates zone corrections for use in network and satellite-based broadcasts on the basis of monitoring stations. The corrections data of the present application refines error correction in user positioning, thereby being able to improve the accuracy of user positioning. The calculation model of the present application is applicable to the calculation of the zone corrections of arbitrary frequency points and combinations of different frequency points. The correction model of combinations of different frequency points can also be obtained from combinations after the calculations at different frequency points. At the same time, other wide-area differential corrections such as equivalent clock errors, grid ionosphere, etc. can be considered in advance and then accumulated in model processing.

By calculating error corrections in the same area, the present application corrects the common error, and refines the accuracy of wide-area differential error correction, thereby improving the accuracy of user positioning. The model proposed by the present application can be extended to users based on carrier-phase observation. The present application takes a zone calculation for observation areas in which the errors in each zone are similar. Therefore, the distance between the monitoring station and the user station is greatly extended, and a user wide-area differential positioning is realized.

The foregoing application has been described in accordance with the relevant legal standard, thus the description is exemplary rather than limiting in nature. Variations and modifications to the disclosed embodiment may become apparent to those skilled in the art and do come within the scope of the application. Accordingly, the scope of legal protection afforded this application can only be determined by studying the following claims.

What is claimed is:

1. A zone correction-based method for improving positioning accuracy of a satellite-based augmentation system, comprising:
S1: dividing an area to be observed into a plurality of observation areas, and configuring a plurality of monitoring stations in each observation area;
S2: said monitoring stations observing at least one satellite to obtain observation data;
S3: acquiring residual data of each monitoring station by processing said observation data, said residual data comprising pseudo-range observation residual and carrier-phase observation residual;
S4: acquiring mean clock error of each monitoring station by processing said pseudo-range observation residual;
S5: acquiring ambiguity reduction value of each observation area by processing said carrier-phase observation residual;
S6: acquiring zone corrections of each observation area by processing said residual and said ambiguity reduction value, said zone corrections data comprising pseudo-range zone corrections and carrier-phase zone corrections; and
S7: providing user station with a zone corrections calling service by a means selected from the group consisting of network and satellite link, wherein said user station obtains three-dimensional coordinates of said user station by calling said zone corrections.

2. The method according to claim 1, wherein in said step S3, the residual are obtained by processing the observation data and by using formula (1) to calculate the pseudo-range observation residual error of a j-th satellite by an i-th monitoring station ΔPᵢ^{j}(f) and the carrier-phase observation residual error of said j-th satellite by said i-th monitoring station ΔLᵢ^{j}(f):
$$\{ \begin{matrix}Δ {P}_{i}^{j} ( f ) = d {ρ}_{i}^{j} + c \cdot {dt}_{i} - c \cdot Δ {dt}^{j} + Δ {I}_{i}^{j} ( f ) + Δ {D}_{i}^{j} + {δ}_{i}^{j} \\ Δ {L}_{i}^{j} ( f ) = d {ρ}_{i}^{j} + c \cdot {dt}_{i} - c \cdot Δ {dt}^{j} + {N}_{i}^{j} - Δ {I}_{i}^{j} ( f ) + Δ {D}_{i}^{j} + {v}_{i}^{j}\end{matrix} \qquad ( 1 )$$
Wherein, i and j are natural numbers greater than zero; f is frequency; dρᵢ^{j} is the distance error between said i-th monitoring station and said j-th satellite; c is the speed of light; dtᵢ is the monitoring station clock error of said i-th monitoring station; dt^{j} is the target clock error of said j-th satellite; Nᵢ^{j} is ambiguity parameter; ΔIᵢ^{j}(f) is delay correction error of ionospheric model related to frequency; Dᵢ^{j} is delay of the tropospheric error between said i-th monitoring station and said j-th satellite; ΔDᵢ^{j} is delay correction error of tropospheric model between said i-th monitoring station and said j-th satellite; δᵢ^{j} and νᵢ^{j} of is the other residual error of pseudo-range and carrier phase between said i-th monitoring station and said j-th satellite.

3. The method according to claim 2, wherein in said step S4, mean clock error value of said i-th monitoring station c·dt̅ᵢ are obtained by processing said pseudo-range observation residual and by using formula (2):
$$c \cdot d {\overline{t}}_{i} = \frac{{\sum }_{j = 1}^{n} Δ {P}_{i}^{j} ( f )}{n} \qquad ( 2 )$$
Wherein, n is the total number of satellites observed at said i-th monitoring station.

4. The method according to claim 3, wherein in said step S5, the ambiguity reduction value of each observation area dΔL′ᵢ^{j}(f)|ₜ are obtained by processing said carrier-phase observation residual and by using formula (3);
$$\{ \begin{matrix}d Δ {L}_{i}^{′ j} ( f ) {\vert}_{t} = \frac{{\sum }_{i = 1}^{m} ( Δ {L}_{i}^{′ j} ( f ) {{\vert}_{t} - Δ {L}_{i}^{′ j} ( f ) \vert}_{t - 1} )}{m} \\ Δ {L}_{i}^{′ j} ( f ) = Δ {L}_{i}^{j} ( f ) - c \cdot d {\overline{t}}_{i} + {v}_{i}^{j}\end{matrix} \qquad ( 3 )$$
Wherein, ΔL′ᵢ^{j}(f) is the carrier-phase residual corrections after deducting said monitoring station clock error; m is the number of said monitoring stations in the current observation area; c·dt̅ᵢ is the mean clock error value of the i-th monitoring station; and t is epoch number.

5. The method according to claim 4, wherein in said step S6, said pseudo-range zone corrections ΔP^{j}(f) and carrier-phase zone corrections ΔL^{j}(f)|ₜ are obtained by processing said residual and said ambiguity reduction value and by using formula (4):
$$\{ \begin{matrix}Δ {P}^{j} ( f ) = \frac{{\sum }_{i = 1}^{m} Δ {P}_{i}^{′ j} ( f )}{m} \\ Δ {L}^{j} ( f ) {\vert}_{t} = Δ {L}_{i}^{′ j} ( f ) {\vert}_{t - 1} + d Δ {L}_{i}^{′ j} ( f ) {\vert}_{t} \\ Δ {P}_{i}^{′ j} ( f ) = Δ {P}_{i}^{j} ( f ) - c \cdot d {\overline{t}}_{i} + {δ}_{i}^{j}\end{matrix} \qquad ( 4 )$$
Wherein, t is epoch number, and c·dt̅ᵢ is mean clock error value of said monitoring stations.
